(19) United States
(12) Patent Application Publication
(10) Pub. No.: US 2001/0042230 A1
(43) Pub. Date: Nov. 15, 2001

(54) Sector validation for use in ECC engine validation

(75) Inventors: Steve Scott Williams, Longmont, CO (US); Joseph Lee Wach, Longmott, CO (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 09/853,564

(22) Filed: May 10, 2001

Related U.S. Application Data
(60) Provisional application No. 60/202,884, filed on May 10, 2000.

(51) Int. Cl. G06F 11/00

(52) U.S. Cl. 714/703

(57) ABSTRACT

A method of validating an error correction code engine of a disc drive includes choosing a physical sector to use for running a validation test for validating the error correction code engine, determining if the physical sector is good, and performing the validation test using the physical sector if the physical sector is good. Another method of validating an error correction code engine in a disc drive includes receiving a first command from a host connected to the disc drive, determining whether to disable one or more of the plurality of error correction code functions in response to the command, disabling the one or more error correction code functions if the command indicates to disable the one or more error correction code functions and executing the command so that the host can validate the error correction code engine.

### RELATED APPLICATIONS

This application claims priority of U.S. provisional application Ser. No. 60/202,884, filed May 10, 2000.

### FIELD OF THE INVENTION

This application relates generally to disc drives and more particularly to validation of disc drive physical sectors that are used for testing error correction coding engines.

### BACKGROUND OF THE INVENTION

Digital information storage devices, such as disc drives, store information in the form of binary bits. During transfer of data between the disc media and the control portions of the disc drive, errors sometimes occur. Errors can also be caused by defects in the disc storage medium. These errors must be corrected if the storage device is to be useful.

Correction of this information is accomplished by deriving additional bits of information, called check bits or redundancy, by processing the data mathematically, appending the check bits to the original data bits during the storage process, and reprocessing the data and check bits mathematically to detect and correct erroneous data bits at the time the information is retrieved. The process of deriving the check bits is called encoding and one class of codes often used in the process of encoding is Reed-Solomon codes. Each class of codes has an encoding rule.

Encoding of error correction information is accomplished by processing a set of n data bits, herein called a data block, to devise a set of r check bits, according to the encoding rule. The r check bits comprise an error correction code (ECC), and there exists one unique ECC for each combination of bits in a data block. An encoder processes the data block with the encoding rule to create the ECC and appends the ECC to the data block to form a data sector that is stored on a disc at a physical sector. When the data sector is read from the disc, a decoder processes the data sector to detect the presence of error(s) and to correct any error(s) present before transferring the data bits for further processing.

The encoder and decoder are herein referred to collectively as an ECC engine. An ECC engine is typically implemented in software or logic circuits. The ECC engine receives a data block, generates a unique ECC for that data block, and appends the ECC to the data block to create a data sector. Later, when the data sector is retrieved, the ECC engine decodes the data sector. Since the ECC is unique to a particular data block, the ECC engine is capable of detecting errors. If errors are detected, the ECC engine can attempt to correct them. The ECC engine can correct up to a certain maximum number of errors, depending on the power of the encoding rule implemented.

Users of disc drives, such as original equipment manufacturers (OEMs), generally certify the disc drives that are used in their equipment. Certification tests of the ECC engine portion of the disc drive are part of the certification. Certification tests involve a host, such as a computer, issuing commands to the disc drive being tested. Typically, the four possible commands are ‘write long’, ‘read long’, ‘read’, and ‘write’. Write long commands and read long commands typically involve 512 bytes(the data block) plus four additional bytes. A regular read or write involves 512 bytes. A host command consists of three parts: <command opcode>, <disc location>, <number of sectors>. The disc location is an address identifying a physical sector to which the disc drive should write or from which the disc drive should read the designated number of data sectors. The ‘read long’ and ‘write long’ commands typically do not perform ECC engine functions. The ‘read long’ and ‘write long’ commands operate on only one sector per command.

A typical ECC engine test involves insertion of predetermined errors into a test data block of a test data sector that is written to a test physical sector. The host reads a data sector, including a data block and an appended ECC, and then changes one or more bits in the data block. After bits have been changed in the data block, the ECC does not correspond to the data block. Thus, the data sector is a faulty data sector. The host then commands the disc drive to write the data sector with the changed bits. To force the disc drive to store the faulty data sector, the host circumvents the disc drive's usual ECC engine functions. Traditionally this has been accomplished using the ‘write long’ command.

When the disc drive receives a ‘write long’ command, the ECC engine does not append a generated ECC to the data. The disc drive writes the test data sector to the designated physical sector. Typically, after the ‘write long’ command, the host issues a ‘read’ command from the test physical sector. Upon receiving this command, the disc drive performs the read command with ECC engine error detection and correction applied as in normal operation. If the ECC engine is functioning properly, it detects the inserted errors and corrects them if it can. This approach assumes that the physical sector used for ECC engine validation is functioning properly.

However, the selection of a physical sector to use for testing is arbitrary and the physical sector may have physical defects. If a physical sector in a medium has some inherent flaw, the sector is called a bad sector. For example, a physical flaw could exist in a region of the chosen physical sector, such that a positive magnetic polarization cannot be achieved in that region, and the value read from that region is constant, regardless of what information the disc drive attempts to write to that region. Frequently when a bad sector is chosen as a test sector, the flaw in the region introduces errors in the test results.

This introduction of errors renders conventional ECC engine certification tests like that shown above useless in many instances. The particular case where the certification test is rendered useless is that in which the host introduces n errors into the test data sector, and unknowingly selects a bad physical sector on which to test the ECC engine. The bad physical sector has the effect of creating m additional errors. If the sum of n plus m is greater than the power of the ECC engine to correct, an otherwise valid ECC engine will, erroneously, be declared invalid.

In the conventional ECC engine validation technique, no physical sector validation is performed. As a result, when the test physical sector is bad, the ECC engine may be designated as having failed when, in fact, the ECC engine is working properly. As shown above, this happens when the sum of the number of bits changed in the original data block plus the number of bits corrupted as a result of the bad test sector exceeds the power of the ECC engine. Without prior validation of the test physical sector, there are two possible results: a high rate of false failures of ECC engines or invalidation of all ECC engine test results. Neither result is helpful.

A proposed method of making ECC engine validation tests more effective is to perform a ‘write long’ command followed by a ‘read long’ command to identify a valid physical sector before performing the test. Because ‘write long’ and ‘read long’ commands typically don't perform any ECC functions, and typically read and write raw data, the host could write a known data sector and read back the data sector. If what was written matches what is read, the physical sector is presumed good. However, with the push for higher storage capacities, disc track densities have become greater. As a result, the disc drive servo controller has little room for error during read operations and read operations frequently misread data sectors. Thus, the method of testing whether a physical sector is bad by issuing a ‘write long’ command followed by a ‘read long’ command often results in declaring a physical sector bad when it is actually good.

In regular read operations, disc drive manufacturers have dealt with this problem by retrying a read if the ECC engine detects errors. However, prior approaches do not implement ECC error detection in ‘read long’ operations. Nor do prior approaches retry ‘read long’ commands. Thus, there is a need for ‘read long’ commands to retry reads and detect errors when determining whether a physical sector is bad. However, this means that ‘write long’ commands must calculate and append an ECC during physical sector validation but not during ECC engine validation. Prior art approaches do not address both physical sector validation and ECC engine validation.

Accordingly there is a need for a way of properly validating ECC engines of disc drives.

### SUMMARY OF THE INVENTION

Against this backdrop the present invention has been developed. One aspect of the invention involves a method of determining whether a physical sector of a disc drive is good so that the physical sector may be used to validate an Error Correction Code(ECC) engine of a disc drive. The method involves receiving commands from a host and determining whether to disable one or more of a plurality of functions of the ECC engine in response to the received commands. The method further involves disabling a calculating function and appending function of the ECC engine so that raw data can be written to the disc so that a physical sector may be validated. The method further involves disabling an ECC engine error correction function to validate a physical sector. The method further involves keeping an ECC engine error detection function enabled to facilitate repeated reading of a data sector from the physical sector to facilitate validating a physical sector.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a functional block diagram of the disc drive of FIG. 1 in accordance with a preferred embodiment of the present invention.

FIG. 3 is a module diagram illustrating modules of an error correction code (ECC) engine in an exemplary embodiment of the present invention.

FIG. 4 is a flow control diagram illustrating the process of entering into ECC engine validation testing in accordance with a preferred embodiment of the present invention.

FIG. 5 is a flow control diagram illustrating the process of validating a sector in accordance with a preferred embodiment of the present invention.

FIG. 6 is a flow control diagram illustrating the process of determination of whether to disable ECC engine correction.

FIG. 7 is a flow control diagram illustrating the process of receiving and responding to commands.

### DETAILED DESCRIPTION

The invention is described in detail below with reference to the figures. When referring to the figures, like structures and elements shown throughout are indicated with like reference numerals.

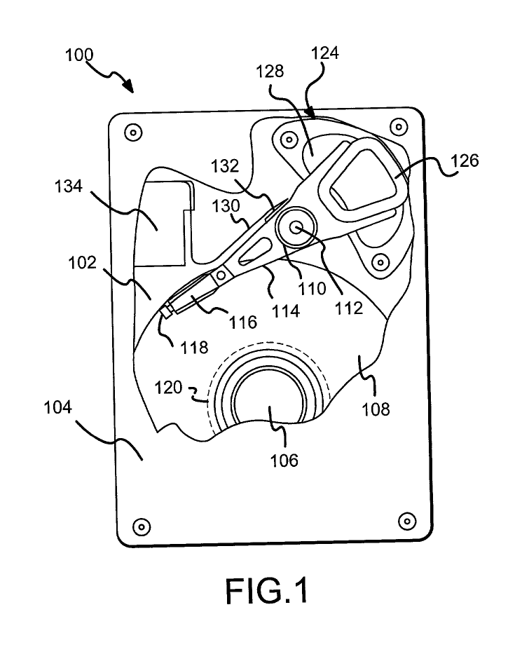

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106 which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 which includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly 130 includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

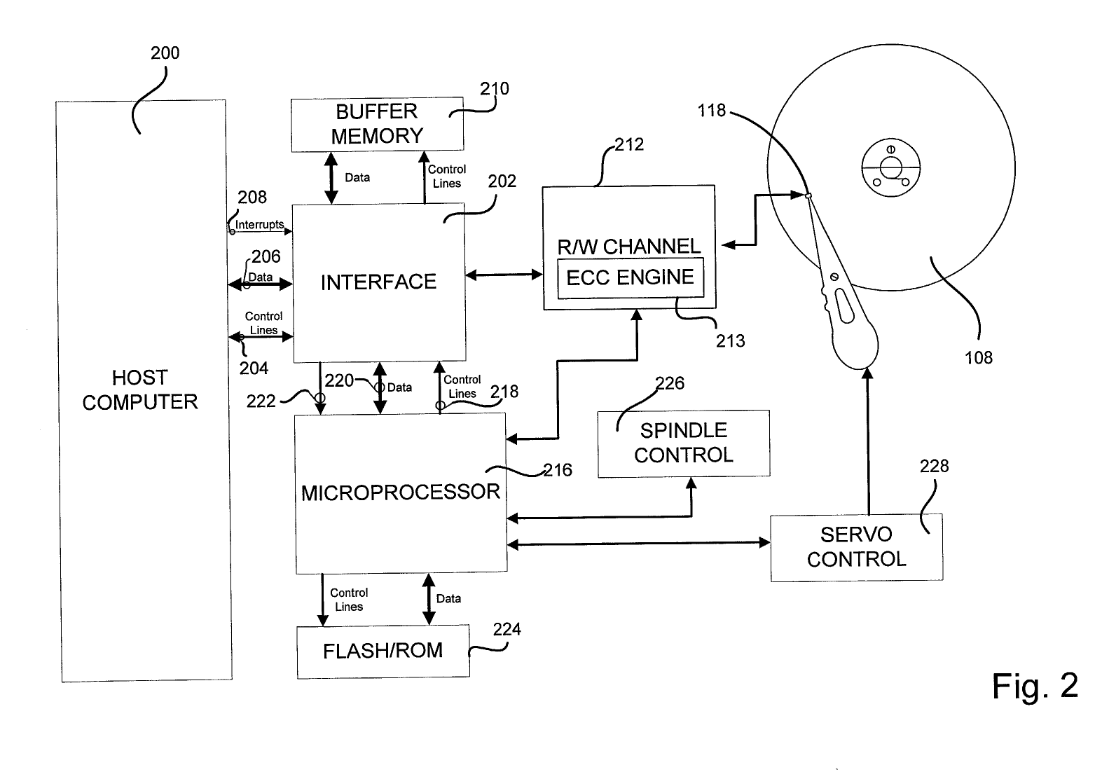

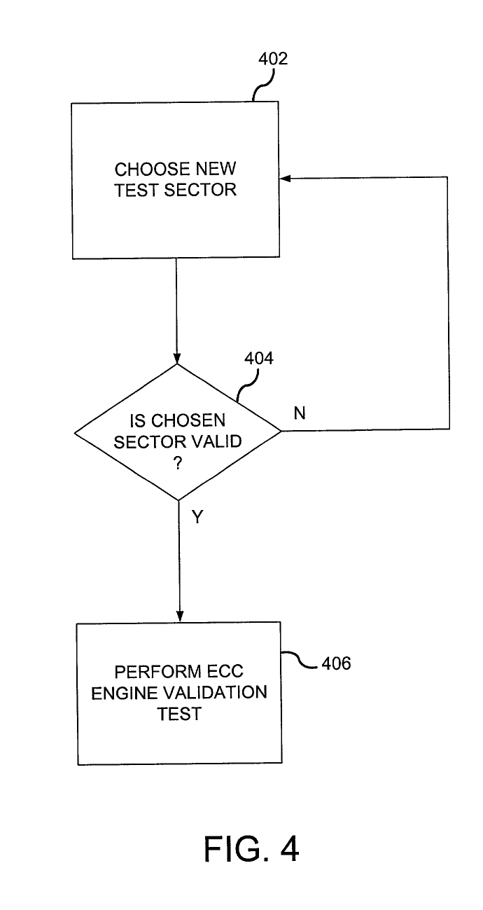

Referring now to FIG. 2, shown therein is a functional block diagram of the disc drive 100 of FIG. 1, generally showing the main functional circuits which are typically resident on a disc drive printed circuit board and which are used to control the operation of the disc drive 100. As shown in FIG. 2, the host 200 is operably connected to an interface application specific integrated circuit (interface) 202 via control lines 204, data lines 206, and interrupt lines 208. The interface 202 typically includes an associated buffer 210 which facilitates high speed data transfer between the host 200 and the disc drive 100. Data to be written to the disc drive 100 are passed from the host to the interface 202 and then to a read/write channel 212, which encodes and serializes the data. A part of the read/write channel 212 is an error correction code(ECC) engine module 213. The ECC engine 213 typically has a set of functions implemented in hardware or software modules. These functions preferably include an ECC error detecting function, an ECC error correcting function, an ECC calculating function that calculates an ECC based on a data block, and an appending function that appends a calculated ECC onto a data block to create a data sector. The ECC engine 213 can preferably disable and enable one or more of the detecting, correcting, calculating, and appending functions. The modules in the ECC engine will be discussed in more detail with reference to FIG. 4.

The read/write channel 212 also provides the requisite write current signals to the heads 118. To retrieve data that has been previously stored by the disc drive 100, read signals are generated by the heads 118 and provided to the read/write channel 212, which processes and outputs the retrieved data to the interface 202 for subsequent transfer to the host 200. Such operations of the disc drive 100 are well known in the art and are discussed, for example, in U.S. Pat. No. 5,276,662 issued Jan. 4, 1994 to Shaver et al.

As also shown in FIG. 2, a microprocessor 216 is operably connected to the interface 202 via control lines 218, data lines 220, and interrupt lines 222. The microprocessor 216 provides top level communication and control for the disc drive 100 in conjunction with programming for the microprocessor 216 which is typically stored in a microprocessor memory (MEM) 224. The MEM 224 can include random access memory (RAM), read only memory (ROM) and other sources of resident memory for the microprocessor 216. Additionally, the microprocessor 216 provides control signals for spindle control 226, and servo control 228.

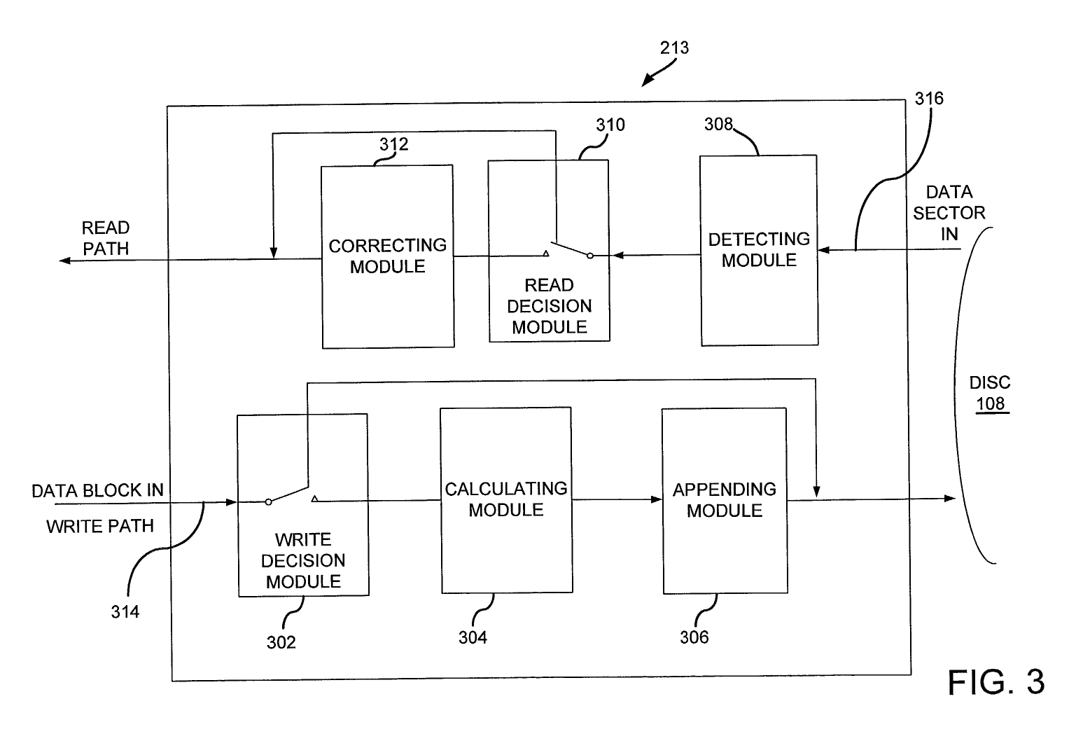

Referring now to FIG. 3, shown therein is a module diagram of modules that are included in an error correction code engine in an exemplary embodiment of the present invention. Shown in FIG. 3 is the ECC engine 213 having a write decision module 302, a calculating module 304, an appending module 306, a detecting module 308, a read decision module 310, and a correcting module 312. The ECC engine 213 can also be viewed as including two data paths: a write path 314, and a read path 316.

The host 200 typically commands the disc drive to read data from and write data to one of the discs 108 in the disc drive 100. When the host 200 commands the disc drive 100 to write data, the host 200 sends a data block to the disc drive 100. The data block enters the ECC engine 213 on the write path 314 and first enters the write decision module 302. The write decision module 302 preferably uses the command to determine whether to send the data block directly to the disc 108 or to send the data block to the calculating module 304. If the write decision module 302 does not send the data to the calculating module 304 then it effectively disables the calculating module 304 and the appending module 306. Writing data without an appended ECC is desirable when the host 200 is validating a physical sector.

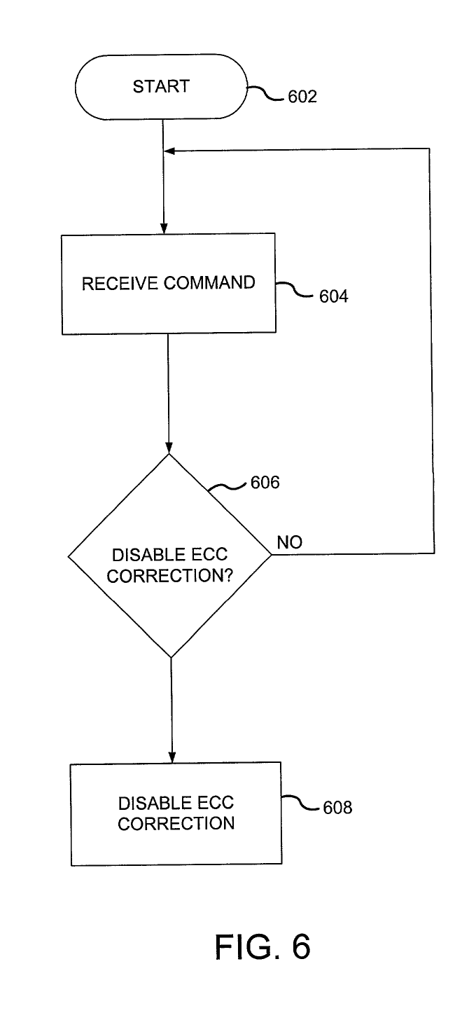

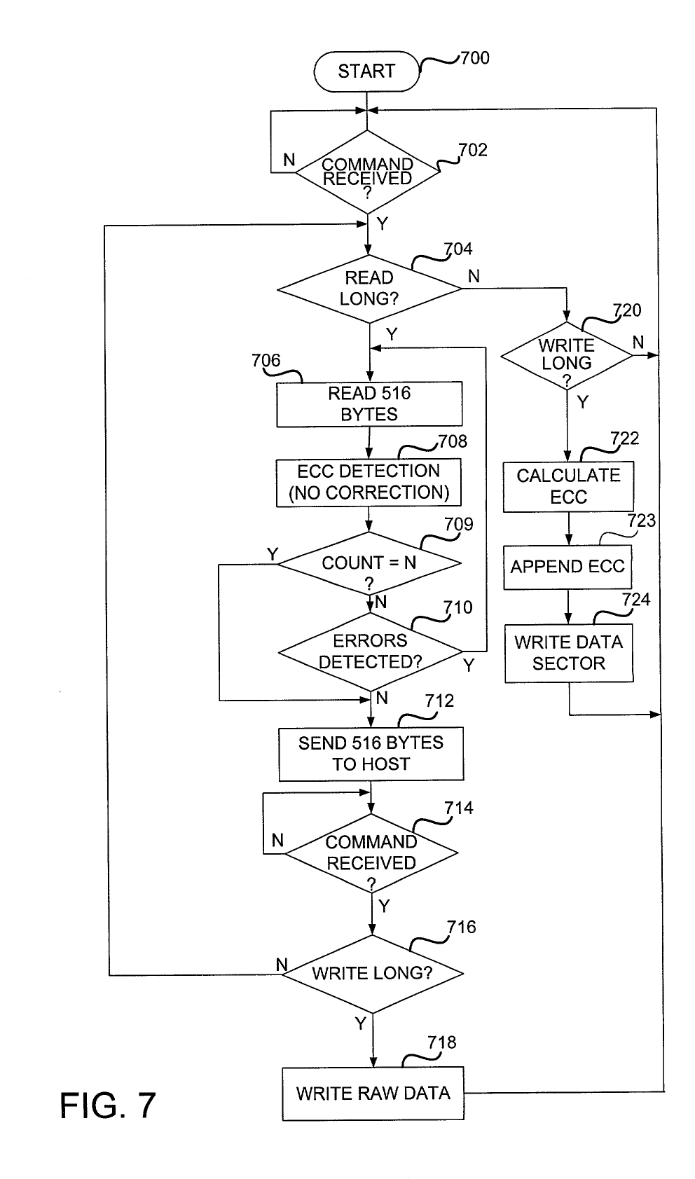

If the write decision module 302 sends the data block to the calculating module 304, the calculating module 304 receives the data block and calculates an ECC for the data block. As was discussed earlier, the ECC is unique to the combination of bits in the data block and the calculating function can be any of a number of ECC calculation functions known in the art. After the ECC is calculated in calculating module 304, the data block and the ECC are sent to the appending module 306. The appending module 306 preferably appends the ECC onto the data block to create a data sector. The data sector may then be written on the disc 108 at a physical sector chosen by the host 200. The write decision module 302 will be discussed in more detail in reference to FIG. 6 and FIG. 7.

When data is read off the disc 108, a data sector typically enters the detecting module 308 of the ECC engine 213. The detecting module 308 detects any errors in the data block of the data sector. Detecting typically involves decoding the data sector to derive an ECC and comparing the derived ECC to the ECC appended to the data block of the data sector. The process of error detecting is well known in the art and can vary in implementation. After the detecting module is 308 detects errors in the data block, the data block and error information is sent to the read decision module 310. The read decision module 310 processes the command from the host 200 and determines whether to send the data block and the error correction information to the correction module 312. As will be discussed in more detail, the read decision module 310 will not send the data block and error correction information to the correcting module 312 when it is indicated that the host 200 is attempting to validate a physical sector. When the host 200 is validating a physical sector, the read decision module 310 disables the correcting function of the ECC engine 213 by bypassing the correcting module 312.

If the read decision module 310 determines that the correcting function should be enabled, the data block and error information are sent to the correcting module 312. The correcting module 312 implements a correcting function that attempts to correct any errors that were detected. ECC error correction is well known in the art and typically involves an algorithm that implements an ECC rule, such as, but not limited to, a Reed-Solomon code. The modules shown in FIG. 3 are exemplary only. In other embodiments, functions that the modules in FIG. 3 perform may be performed outside the ECC engine. Also, in other embodiments, the modules shown in FIG. 3 may be combined.

Referring now to FIG. 4, the host 200 sequences through a series of steps to locate a properly functioning physical sector. As will be discussed in more detail, after the host 200 locates a properly functioning physical sector, ECC engine validation tests are performed using that physical sector. As discussed earlier, using a properly functioning physical sector for certification tests ensures the reliability of the test results.

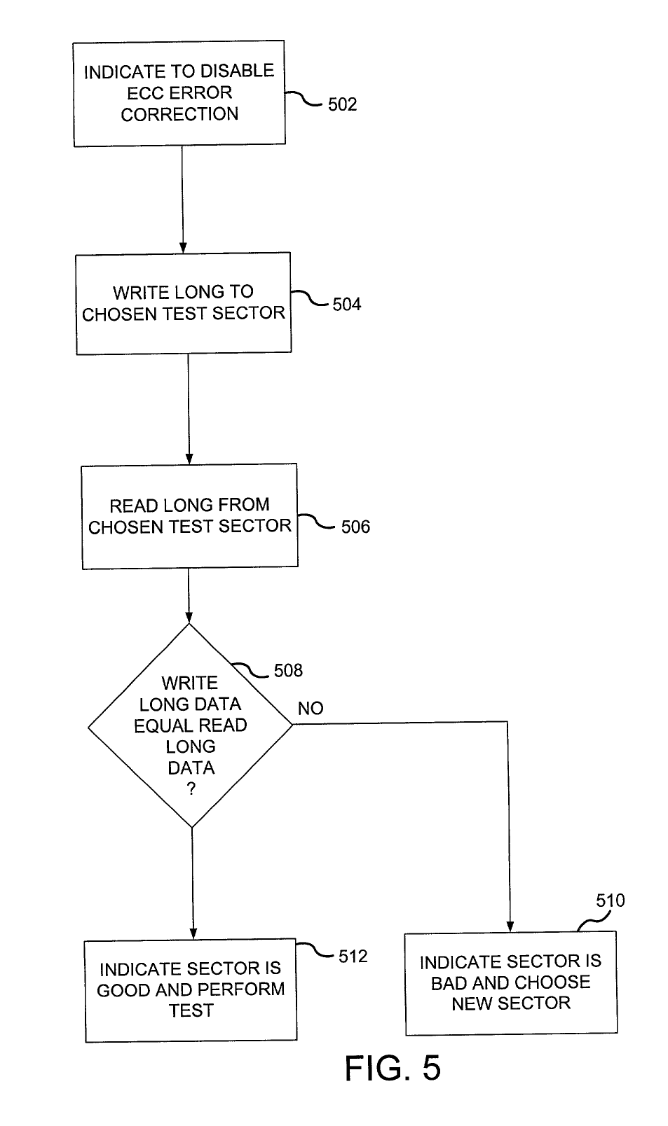

In FIG. 4 processing begins with a choosing operation 402, wherein the host 200 chooses a physical sector to use for testing the ECC engine 213. After the choosing operation 402, control transfers to a determining operation 404, wherein it is determined whether the physical sector chosen in the choosing operation 402 is a bad physical sector. The determining process of the determining operation 404 is discussed in more detail in reference to FIG. 5. If the chosen physical sector is bad, control transfers back to the choose operation 402, where another physical sector is chosen for testing.

If, however, the chosen physical sector is good in the determine operation 404, control transfers to a performing operation 406, wherein the chosen test sector is used to perform certification tests on the ECC Engine 213 of the disc drive 100. The performing operation 406 comprises a sequence of operations involving sending commands to the disc drive 100, and receiving data from the disc drive 100 in response to those commands. The responses are validated during certification tests to determine whether the ECC engine 213 is functioning properly. The current invention renders the ECC engine 213 test results reliable because the physical sector used for the tests has been previously verified as functioning properly.

FIG. 5 illustrates a process of validating a physical sector to use for ECC engine 213 tests in an embodiment of the present invention. The determining operation 404 comprises the steps of validating a chosen physical sector. In FIG. 5, processing begins at an indicating operation 502, wherein the host 200 sends an indicator to the disc drive 100 that the disc drive 100 should disable ECC error correction. The indicator is routed to the ECC engine 213. In response to the indicator, the ECC engine 213 disables the ECC error correction function. Control then transfers to a write operation 504, wherein a command is sent to the disc drive 100 to write a block of long data to the chosen physical sector of the choosing operation 402.

After the write operation 504, control transfers to Read Long From Chosen Test Sector 506. In operation Read Long From Chosen Test Sector 506, a command is sent to the disc drive 100 to read a block of long data from the physical sector chosen in choosing operation 402. In response to this command, the disc drive 100 locates the chosen physical sector and reads a data sector comprising data and an ECC.

Upon reading the data, the ECC Engine 213 would normally decode the sector, detect any errors, and attempt to correct any errors. However, the ECC Engine 213 previously disabled error correction in response to the command of the indicating operation 502. Therefore, the ECC Engine 213 may detect errors in the retrieved data, but it does not change the data by correcting the errors. Thus, in response to the command of reading operation 506, the disc drive 100 transfers data to the host 200 unchanged from how it was read from the physical sector of the disc. Thus, the host 200 receives data that was read from the disc without the ECC Engine 213 having changed any part of the data.

The host 200, advantageously, can now determine if the block of long data written in the writing operation 504 is the same as the block of long data read in the reading operation 506. If the two blocks of data are different, the difference arose from a faulty physical sector. Thus, the host 200 learns a piece of information about the test environment that vastly improves the reliability of certification tests.

Referring again to FIG. 5, the host 200 learns about the chosen physical sector in a determining operation 508 by comparing the block of data written to a physical sector to the block of data read from the physical sector. If the two blocks of data are not equal, control transfers to an indicating operation 510, in which the chosen physical sector is identified as a bad sector and a new physical sector is chosen to validate. If, on the other hand, it is determined in the determining operation 508 that the written data equals the read data, control transfers to an indicating operation 512. In the indicating operation 512, the chosen sector of the choosing operation 402 is identified as a good physical sector and processing continues with the ECC engine certification tests using the chosen physical sector.

The foregoing detailed description concerned the steps that the host 200 preferably takes. As was mentioned earlier, the host 200 issues commands to and receives data from the disc drive 100, whereby the host 200 is able to locate a good, or valid, physical sector. After a valid physical sector is found, the host 200 typically administers certification tests. Modules, such as the ECC engine module 213, in the disc drive 100 are responsive to commands issued by the host 200. As will be discussed in detail below, the ECC engine 213 of the disc drive 100 implements processing in order to determine when to disable the ECC engine 213 error correction function.

Referring to FIG. 6, processing begins with a starting operation 602, wherein the disc drive 100 performs initialization processing and awaits commands from host 200. Control transfers from the starting operation 602 to a receiving operation 604, wherein the disc drive 100 receives a command and stores it in memory 210. Control then transfers to a determining operation 606, wherein processing goes through a series of operations to determine if conditions are correct for the ECC Engine 213 to disable ECC error correction. The processing involved in the determining operation 606 will be discussed in detail with reference to FIG.7.

If it is determined in the determining operation 606 that ECC error correction should not be disabled, control transfers back to the receiving operation 604. If, however, it is determined in the determining operation 606 that ECC error correction should be disabled, control transfers to a disabling operation 608. In the disabling operation 608 the error correction function of the ECC engine 213 is disabled. Disabling can be achieved in any manner.

As mentioned earlier, the host 200 sends commands to the disc drive 100 to validate the functioning of the ECC engine 213. To validate the ECC engine 213, the host 200 first identifies a valid physical sector. To identify a valid sector, the host 200 circumvents the normal error correction operation of ECC engine 213. A set of commands serve as a signal to ECC engine 213 that ECC error correction should be disabled. Interpreting and responding to the signaling commands are steps included in the determining operation 606. These signaling commands are discussed in detail in the embodiment shown in FIG. 7.

Referring now to FIG. 7, therein is shown a flow chart illustrating the process of determining when to disable error correction code functions in accordance with an exemplary embodiment of the present invention. Control initially transfers to a starting operation 700 wherein initialization processing occurs. Control then transfers to a determining operation 702 wherein the disc drive 100 determines whether a first command has been received from the host 200. As was discussed earlier, a command from the host 200 preferably includes a command opcode, a physical test sector, and a designated number of bytes. If a first command is not received, control loops back to the determining operation 702. When a new command is received in the determining operation 702, control transfers to a determining operation 704 wherein it is determined whether the command is a read long command. If the command is a read long command, control transfers to a reading operation 706 wherein 512 bytes plus an appended 4 bytes are read from a designated physical sector. Control then transfers to a detecting operation 708. In the detecting operation 708, the error correction code (ECC) engine 213 detects but does not correct errors.

Control then transfers to the determining operation 709 wherein it is determined whether a predetermined maximum number of reads has been performed. The determining operation 709 is employed to allow for an exit from the reading loop comprising operations 706, 708, and 710. In other words, the determining operation 709 ensures that an endless loop is avoided, wherein errors are continuously detected. If it is determined that the loop has been iterated “N” times, the loop is exited by transferring control to a sending operation 712. If the loop has not been iterated N times, control then transfers to a determine operation 710 wherein it is determined whether errors were detected. If errors were detected, control transfers back to the reading operation 706 wherein the data sector is re-read from the designated physical sector. The reading loop comprising the reading operation 706, the detecting operation 708, and the determining operation 710, is preferably iterated a predetermined number of times in order to validate the physical test sector. The maximum number of times through the loop is limited by the number N in the determining operation 709. If it is determined in the determining operation 710 that errors are not detected, control then transfers to the sending operation 712 wherein the 516 bytes are sent to the host 200.

Control then transfers to the determining operation 714 wherein the disc drive 100 determines whether another command has been received from the host 200. If another command has not been received, control transfers back to the determining operation 714. When the next command is received in the determining operation 714, control then transfers to a determining operation 716. In the determining operation 716 it is determined whether the next command is a write long command. If so, control transfers to a writing operation 718 wherein the disc drive 100 first disables the ECC calculating function and the ECC appending function. Then, in writing operation 718, the disc drive 100 writes raw data received from the host 200 to the designated physical test sector without calculating or appending an ECC. Control then transfers back to the waiting operation 702 wherein the disc drive 100 waits for a next command from the host 200.

If, on the other hand, the command was determined in determining operation 716 to be a command other than a write-long command, control transfers to the determining operation 704 wherein it is determined whether the command is a read-long command. If in the determining operation 704 it is determined that the command is not a read-long command, control transfers to the determining operation 720 wherein it is determined whether the command is a write-long command. If not, control transfers back to the waiting operation 702 wherein the disc drive 100 waits for a next command from the host 200. If, on the other hand, the command is determined to be a write-long command in the determining operation 720 control transfers to the calculating operation 722. In the calculating operation 722 an ECC is calculated for a data block received from the host 200. Control then transfers to the appending operation 723 wherein the calculated ECC is appended to the data block to create a data sector. Control then transfers to the writing operation 724 wherein the calculated ECC is appended to the data block to create a data sector, and the data sector is written to the designated physical test sector. Control then transfers back to the waiting operation 702 wherein the disc drive 100 waits for a next command from the host 200. The embodiment in FIG. 7 is a process of validating a physical test sector by using ECC detection in a read-long command, and a process of determining when to calculate and append an ECC in a write-long command. As was discussed earlier, in a typical ECC engine validation test, the host 200 will follow a write-long command with a regular read command.

In summary, the present invention can be viewed as a method of validating an error correction code engine (such as 213) of a disc drive (such as 100) by choosing (such as 402) a physical sector to use for running a validation test, determining (such as 404) if the physical sector is good, and performing (such as 406) the validation test using the physical sector if the physical sector is good. Preferably, determining whether the physical sector is good involves indicating (such as 502) to disable the error correction function, disabling (such as 708) the error correction function, issuing (such as 504) a write long command to write a data sector to the physical sector, writing (such as 724) the data sector to the physical sector, issuing (such as 506) a read long command to read the data back from the physical sector, reading (such as 706) the data sector from the physical sector in response to the read long command, and comparing (such as 508) the written data sector to the read data sector to determine if they are equal.

Issuing (such as 506) a read long command is one way of indicating to disable the ECC error correction function. The process of reading back the data from the physical sector can include reading (such as 706) the data and detecting (such as 708) errors, if any, in the data. The steps of reading (such as 706) and detecting (such as 708) can be repeated (such as 710) if errors are detected.

Another embodiment of the invention is a method of validating an error correction code engine in a disc drive by receiving a command from a host connected to the disc drive, determining whether to disable an error correction code function (such as 704 and 716), disabling (such as 708 and 718) the error correction code function if indicated, and executing (such as 708 or 718) the command so that the host can validate the error correction code engine. After receiving a read long command, executing the read long command is preferably performed by reading (such as 704) a data sector and detecting (such as 706) any errors in the data sector. The reading (such as 704) and detecting (such as 706) steps are preferably repeated if it is determined (such as 708) that there are errors in the data sector. Subsequent to a write long command, executing the command typically involves calculating (such as 722) an error correction code, appending (such as 723) the error correction code onto the data block to create a data sector, and writing (such as 724) the data sector at the desired physical sector.

Preferably, when the disc drive receives a write long command immediately subsequent to a read long command the disc drive responds by disabling (such as 718) the error correction code calculating function, disabling (such as 718) the appending function in response to the write long command, writing (such as 718) the data block onto a disc of the disc drive at the physical sector.

Another embodiment of the present invention is a disc drive (such as 100) having discs (such as 104) with some good physical sectors and some bad physical sectors, wherein the disc drive (such as 100) includes an ECC engine (such as 213) having an ECC calculating module (such as 304), an appending module (such as 306), and a write decision module (such as 302), wherein the write decision module (such as 302) determines whether to disable a calculating function and an appending function by bypassing the calculating module (such as 304) and the appending module (such as 306). The disc drive preferably includes a detecting module (such as 308), a correcting module (such as 312), and a read decision module (such as 310). The read decision module (such as 310) determines whether to disable a correcting function by bypassing the correcting module (such as 312).

The present invention may also be viewed as an error correction code engine (such as 213) validation system for a data storage device (such as 100) comprising a host computer (such as 200) attached to the data storage device (such as 100). The system includes means for validating the error correction code engine (such as 213).

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

It will be clear that the present invention is well adapted to attain the ends and advantages mentioned as well as those inherent therein. While a presently preferred embodiment has been described for purposes of this disclosure, various changes and modifications may be made which are well within the scope of the present invention. The present invention may be implemented in any storage device that employs an error-control coding scheme which relies on the systematic addition of redundant symbols to the stored information for error detection and correction, and whose media storage unit is capable of inherent flaws that cause systemic errors. For example, the present invention may be implemented in a magnetic tape storage device. Numerous other changes may be made which will readily suggest themselves to those skilled in the art and which are encompassed in the spirit of the invention disclosed and as defined in the appended claims.

What is claimed is:

1. A method of validating an error correction code engine of a disc drive comprising steps of:
(a) choosing a physical sector to use for running a validation test for validating the error correction code engine;
(b) determining if the physical sector is good; and
(c) performing the validation test using the physical sector if the physical sector is good.

2. The method of claim 1 wherein the error correction code engine includes an error correction function and wherein the determining step (b) comprises steps of:
(b)(i) commanding the disc drive to disable the error correction function;
(b)(ii) disabling the error correction function;
(b)(iii) issuing a write long command to write a first data sector to the physical sector;
(b)(iv) writing the first data sector to the physical sector in response to the write long command;
(b)(v) issuing a read long command to read a second data sector corresponding to the first data sector from the physical sector;
(b)(vi) reading the second data sector from the physical sector in response to the read long command; and
(b)(vii) comparing the first data sector to the second data sector to determine if the first data sector equals the second data sector.

3. The method of claim 2 wherein the indicating step (b)(i) comprises issuing a read long command to read a third data sector from the physical sector.

4. The method of claim 2 wherein the error correction code engine includes an error detecting function and wherein the reading step (b)(vi) comprises steps of:
(b)(vi)(1) reading the second data sector from the physical sector;
(b)(vi)(2) detecting any errors in the second data sector;
(b)(vi)(3) repeating steps (b)(vi)(1) and (b)(vi)(2) until either no errors are detected or a predetermined number of repetitions is performed to preclude reporting a valid sector as invalid.

5. A method of validating an error correction code engine in a disc drive, the error correction code engine having a plurality of error correction code functions, the method comprising steps of:
(a) receiving a first command from a host connected to the disc drive;
(b) determining whether to disable one or more of the plurality of error correction code functions in response to receipt of the command;
(c) disabling the one or more error correction code functions if the command indicates to disable the one or more error correction code functions; and
(d) executing the command so that the host can validate the error correction code engine.

6. The method of claim 5 wherein the first command is a read long command having a physical sector, and wherein one of the plurality of error correction code functions is a detecting function able to detect errors in a data sector, and wherein the executing step (d) comprises steps of:
(d)(i) reading a data sector from the physical sector;
(d)(ii) detecting any errors in the data sector;
(d)(iii) repeating steps (d)(i) and (d)(ii) until either no errors are detected or a predetermined number of repetitions is performed to preclude reporting a valid sector as invalid.

7. The method of claim 5 wherein the first command is a write long command having a physical sector and a data block, and wherein one of the plurality of error correction code functions is an error correction code calculating function able to calculate an error correction code for the data block, and wherein another one of the plurality of the error correction code functions is an appending function able to append the error correction code onto the data block to create a data sector, and wherein the executing step (d) comprises steps of:
(d)(i) calculating an error correction code for the data block;
(d)(ii) appending the error correction code onto the data block to create a data sector;
(d)(iii) writing the data sector onto a disc of the disc drive at the physical sector.

8. The method of claim 6 wherein one of the plurality of error correction code functions is an error correction code calculating function operable to calculate an error correction code for a data block, and wherein another one of the plurality of the error correction code functions is an appending function to append the error correction code onto the data block to create a data sector, the method further comprising steps of:
(e) receiving a second command from the host, wherein the second command is a write long command including the physical sector and a data block;
(f) disabling the error correction code calculating function in response to the write long command;
(g) disabling the appending function in response to the write long command;
(h) writing the data block onto a disc of the disc drive at the physical sector.

9. A disc drive comprising:
a disc having a plurality of physical sectors; and
an error correction code(ECC) engine operable to detect a bad physical sector, the ECC engine having an ECC calculating module, an appending module, and a write decision module, wherein the write decision module determines whether to disable a calculating function and an appending function by bypassing the ECC calculating module and the appending module.

10. The disc drive of claim 9 wherein the ECC engine function further comprises:
a detecting module, a correcting module, and a read decision module, wherein the read decision module determines whether to disable a correcting function by bypassing the correcting module.

11. An error correction code engine validation system for a data storage device comprising:
a host computer attached to the data storage device having a read/write channel including an error correction code engine, wherein the error correction code engine includes an error correction code correction function and an error correction code detection function;
a validation means in the disc drive for validating the error correction code engine, wherein the validation means utilizes read, read long, and write long commands to identify a valid sector to be used for validation and then disables error correction code correction function.
